(19) United States
(12) Patent Application Publication
(10) Pub. No.: US 2008/0176742 A1
(43) Pub. Date: Jul. 24, 2008

(54) Method For Producing Catalyst For Treating Exhaust Gas

(75) Inventors: Katsumi Nochi, Hiroshima (JP); Masanao Yonemura, Hiroshima (JP); Kozo Iida, Hiroshima (JP); Yoshiaki Obayashi, Hiroshima (JP); Shigeru Nojima, Hiroshima (JP); Toshiyuki Onishi, Nagasaki (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., Tokyo (JP)

(21) Appl. No.: 11/576,041

(22) PCT Filed: Mar. 4, 2005
(86) PCT No.: PCT/JP05/03791

§ 371 Date: Nov. 2, 2007

(51) Int. Cl. B01J 37/02; B01J 23/42; B01J 23/44; B01J 23/46; B01J 23/50; B01J 23/52; B01J 23/58; B01J 23/63; B01J 23/648; B01J 23/652; B01J 23/656; B01J 23/89; B01J 27/185

(52) U.S. Cl. 502/208; 502/300; 502/325; 502/347; 502/344; 502/319; 502/324; 502/338; 502/345; 502/304; 502/303; 502/340; 502/305; 502/321; 502/353; 502/240; 502/355; 502/242; 502/351; 502/350; 502/217

(57) ABSTRACT

An object of the present invention is to provide a method for producing a catalyst for treating exhaust gas, enabling a smaller amount of a noble metal to be supported and reducing the production cost thereof. There is provided a method for producing a catalyst for treating an exhaust gas containing carbon monoxide and volatile organic compounds, wherein the method comprises: preparing, as a pH buffer solution, an aqueous metal salt solution in which at least one metal salt is dissolved; reductively-treating the aqueous metal salt solution while keeping the pH constant to prepare a metal colloid solution; and immersing a carrier in the metal colloid solution to support the metal on the carrier. The supported amount of metal may be 0.7 g/L or less per one of the metals.

### TECHNICAL FIELD

The present invention relates to a method for producing a catalyst for treating exhaust gas, and more specifically to a method for producing a catalyst for treating an exhaust gas containing carbon monoxide and volatile organic compounds.

### BACKGROUND ART

NOₓ, SOₓ, CO (carbon monoxide), unburned hydrocarbons, and the like are contained in exhaust gases discharged from various industrial equipment such as, for example, automobiles, aircrafts, and equipment in a variety of factories. Catalysts for treating exhaust gas are used for treating such substances contained in exhaust gas.

For example, Japanese Patent Laid-Open No. 10-309462 discloses a NMHC oxidation catalyst in which Pt (platinum) is supported on an alumina carrier.

Here, such conventional catalysts for treating exhaust gas use such expensive noble metals as Pt. To support Pt on alumina as a carrier, for example, by an impregnation method, it is described that Pt is prepared as an aqueous solution of a form such as the nitrate, into which powdered alumina is then charged before, as appropriate, stirring; the alumina thus impregnated with the platinum compound is then dried and fired by an ordinary method.

However, the conventional methods have had high production costs because large amounts of expensive noble metals such as Pt are supported. In addition, lowering the amount of noble metal for reducing a production cost decreased the burning rate of the object to be treated, resulting in the insufficient performance of the catalyst.

Patent Document 1: Japanese Patent Laid-Open No. 10-309462

Made in view of the above-described circumstances, the present invention has an object of providing a method for producing a catalyst for treating exhaust gas, enabling a smaller amount of a noble metal to be supported and reducing the production cost thereof.

### DISCLOSURE OF THE INVENTION

For achieving the above object, the present invention provides a method for producing a catalyst for treating an exhaust gas containing carbon monoxide and volatile organic compounds, comprising: preparing, in the form of a pH buffer solution, an aqueous metal salt solution in which at least one metal salt is dissolved; reductively-treating the aqueous metal salt solution while keeping the pH constant to prepare a metal colloid solution; and immersing a carrier in the metal colloid solution to support the metal on the carrier.

According to the present invention, there is provided a method for producing a catalyst for treating exhaust gas, enabling a smaller amount of a noble metal to be supported and reducing the production cost thereof. Specifically, in the method for producing a catalyst for treating exhaust gas according to the present invention, the aqueous metal salt solution can be prepared as a pH buffer solution to keep the pH of the solution constant despite the evaporation thereof during colloid production. Also in the supporting step, the pH of the metal colloid solution can be kept constant irrespective of the immersion process because the pH-buffer action is inherited to the colloid solution. This stabilizes the reduction rate of the metal and the rate of supporting the metal on the colloid carrier and enables the metal to be supported in a highly dispersed state while making possible the preparation of extremely fine colloid particles.

### BEST MODE FOR CARRYING OUT THE INVENTION

The method for producing a catalyst for treating exhaust gas according to the present invention is described below in further detail.

According to the method for producing a catalyst for treating exhaust gas of the present invention, there is produced a catalyst for treating an exhaust gas containing carbon monoxide and volatile organic compounds. Thus, the present invention is applicable to exhaust gases discharged from so-called lean-burn gas engines. The term “volatile organic compounds” generally refers to hydrocarbons other than methane and ethane.

According to the method for producing a catalyst for treating exhaust gas of the present invention, there is prepared, in the form of a pH buffer solution, an aqueous metal salt solution in which at least one metal salt is dissolved. The metal salt is preferably a salt of a noble metal actualizing catalytic activity. A plurality of salts of noble metals may be also used. Preferred salts of noble metals are nitrates, chlorides, acetates and complex salts of Ir, Rh, Ru, Pt, Pd, Ag and Au. Of these salts, more preferred salts are nitrates, chlorides, acetates and complex salts of Ir, Pt and Pd.

The pH buffer solution (a metal salt solution to be reductively-treated) is prepared, for example, by a suitable one of the following procedures.

The metal salt is dissolved in water to prepare an aqueous solution thereof. Then, a reducing agent is charged thereinto. A pH buffer solution is mixed in the resultant aqueous metal salt solution to prepare an intended pH buffer solution containing the metal salt. Each of the preceding pH buffer solution and the buffer solution mixed in the aqueous metal salt solution represents a pH buffer solution. The reducing agent and the pH buffer solution may be simultaneously charged into the aqueous metal salt solution originally prepared, or the reducing agent may be charged after mixing the pH buffer solution into the aqueous solution. Alternatively, the metal salt and the pH buffer solution may be mixed in an aqueous mixture of water such as ion exchanged water and the reducing agent. In either procedure, the water used is preferably employed after removing dissolved oxygen by boiling.

The compound usable as “reducing agent” is preferably an organic acid, and examples thereof can include carboxylic acids such as sodium citrate, potassium citrate, acetic acid, formic acid, and malic acid, alcohols such as methanol, ethanol, and propanol, ethers such as diethyl ether, and ketones such as methyl ethyl ketone.

The action lessening a change in pH due to addition of acid or base or to dilution is called buffer action, and an aqueous solution having such action is referred to as a pH buffer solution. An aqueous mixture of a weak acid and a strong base, a weak base and a strong acid, or a weak acid and a weak base is a typical pH buffer solution. Examples of the pH buffer solution adoptable in the present invention include an aqueous ammonia/ammonium chloride buffer solution and an acetic acid/sodium acetate buffer solution.

According to the present invention, the resultant aqueous metal salt solution prepared in the form of a pH buffer solution is reductively-treated to prepare a metal colloid solution. The reduction reaction generally proceeds by heating the pH buffer solution (aqueous metal salt solution) at about 80° C. The pH buffer solution can be kept at a constant pH (1 to 14) despite the evaporation of the solution during colloid production. In the reduction reaction, metal colloid particles are produced by the reduction reaction of the metal dissolved as an ion, and by completion of the reaction, a metal colloid solution is prepared.

A carrier can be then immersed in the metal colloid solution to support the metal on the carrier. Treatments as described below may be carried out according to the form of final products.

(1) A powdery, granular, pellet-form, tablet-form or monolith type (e.g. honeycomb) carrier (also referred to as a substrate) is immersed in the metal colloid solution, then dried, and, as needed, fired to provide a final catalyst product.

(2) The powdery catalyst obtained as described above is sized to a predetermined particle size or granulated, or pressure-molded or extrusion-molded. The molding is cut to a predetermined length for pelletization.

Here, also in such a supporting step, the pH of the metal colloid solution can be kept constant (1 to 14) irrespective of the immersion process because the pH buffer action is inherited to the colloid solution.

As a result, according to the present invention, the reduction rate of the metal and the rate of supporting the metal on the colloid carrier are stabilized and the metal can be supported in a highly dispersed state on the carrier while making possible the preparation of extremely fine colloid particles.

According to the present invention, a resultant catalyst can have a plurality of active metals supported thereon. Specifically, one or more noble metals and/or base metals can be contained therein as active metals. Even a supported amount of 0.7 g/L or less per one of these metals can exhibit a sufficient effect.

In the description in the present specification and claims, the wording of “and/or” as described above is used to collectively and strictly indicate three ways of meaning, i.e. two juxtaposed terms both of which are merged and eithers of the terms according to “Rules for the layout of Japanese Industrial Standards” in JIS Z 8301.

The above-described noble metal supported is preferably at least one selected from the group consisting of Ir, Rh, Ru, Pt, Pd, Ag, Au, and oxides thereof. The above-described base metal supported is preferably at least one selected from the group consisting of the metals Cr, Mn, Fe, Co, Cu, Ce, La, Ba, Na, Ca, K, W, Mo, V, P, and oxides thereof.

The compound constituting the carrier is preferably at least one selected from the group consisting of SiO₂, Al₂O₃, TiO₂, ZrO₂, SiO₂—Al₂O₃, TiO₂—SiO₂, TiO₂—Al₂O₃, TiO₂—ZrO₂, SO₄/ZrO₂, SO₄/TiO₂, and SO₄/TiO₂—ZrO₂.

The base metal and/or the oxide thereof is preferably supported on a catalyst for treating exhaust gas on which colloid particles (noble metal) have been supported.

### EXAMPLE 1

In order to demonstrate the effect of the method for producing a catalyst for treating exhaust gas according to the present invention, tests and comparison as shown in Table 1 were performed. Nos. 1 to 54 indicate Test Examples 1 to 54, respectively, according to the present invention, and the results of Comparative Examples 1 to 3 are also shown.

Test Examples 1 to 13 and 35 to 54 were carried out by preparing metal colloid solutions each containing a single noble metal or an oxide of a noble metal. These solutions were prepared according to the following procedure.

(1) There was produced an ion exchanged water from which dissolved oxygen was removed by boiling for one hour.

(2) Reducing agents were provided. In Table 1, the reducing agents were all specified so as to provide a volume ratio of ion exchanged water/reducing agent at 1/1.

(3) In 0.5 litter of the ion exchanged water was mixed 0.5 litter of each reducing agent (a reducing agent solution) to make 1 litter of an aqueous mixture.

(4) A metal salt corresponding to each active metal and 0.02 litter of an acetic acid/sodium acetate aqueous solution (pH 2) were added to the above-described aqueous mixture to prepare a pH buffer solution containing 1 mmol of the active metal.

(5) The pH buffer solution was reductively-treated for one hour while keeping at 80° C. The pH of the solution was kept at 2 during reduction. This provided a metal colloid solution.

(6) A carrier was immersed in 250 cc of the metal colloid solution to support the active metal thereon at a ratio as shown in Table 1. The pH was also kept at 2 in the supporting. After the supporting thereof, the resultant catalyst was dried at 110° C. and fired at 500° C. The supported amount of the catalyst is shown as the active component composition (active metal 1) in Table 1.

Test Examples 14 to 34 are test examples in each of which a different noble or base metal was further supported. Corresponding metal salts were provided; aqueous metal salt solutions (each containing a reducing agent) were prepared as described above; and all of the aqueous metal salt solutions were mixed, which was subjected to similar reduction and immersion treatments. The supported amounts of the catalysts are shown as the active component compositions (active metals 1 and 2 or 1 to 3) in Table 1.

Comparative Example 1 was conducted by an impregnation method, and Comparative Examples 2 and 3 were performed as described in Test Examples but without using any pH buffer solution.

The procedure of Test Example 1 will be described in further detail.

### TEST EXAMPLE 1

Preparation of a metal colloid solution:

To 0.5 litter of ion-exchanged water was added 0.5 litter of ethanol to prepare 1 litter of an aqueous mixture. The mixture was boiled for one hour to remove dissolved oxygen. To this mixture were added 2.4 g of chloroiridium acid and 0.02 litter of an acetic acid/sodium acetate aqueous solution to prepare a mixed aqueous solution of pH buffer solution (containing 1 mmol Ir). The solution was reductively-treated for one hour while keeping at 80° C. The solution was kept at pH2 during the reduction. The solution was cooled with ice after confirming the color change thereof from red to black to make a metal colloid solution.

Supporting the metal colloid on a carrier:

A honeycomb substrate coated with 100 g/m² of γ-Al₂O₃ was immersed in 250 cc of the metal colloid solution to support a predetermined amount of Ir thereon. The pH of the solution in the supporting was set to the same as that described above. The catalyst supported was dried at 110° C. and then fired at 500° C. for 5 hours, and the resultant catalyst was called Test Example 1.

Conditions for evaluating the rate of reaction:

Test examples and Comparative Examples prepared as described above were subjected to reaction rate evaluation test using conditions described below. The results are as shown in Table 1. It turns out that in Test Examples in accordance with the present invention, sufficient catalytic activities are achieved despite the small amounts of catalysts supported.

CO: 65 ppm, C₂₋ₒᵣ₋ₘₒᵣₑ hydrocarbons: 30 ppm, NOₓ: 65 ppm

O₂: 15%, CO₂: 5%, H₂O: 7%, N₂: balance, GHSV: 140,000 h⁻¹,

Gas amount: 200 NL/h,

Catalyst layer temperature: 300° C.

In this respect, the reaction rate of gas is expressed by the following equation.

The reaction rate (%) of CO=(1−outlet CO concentration/inlet CO concentration)×100

The reaction rate (%) of C₂₋ₒᵣ₋ₘₒᵣₑ hydrocarbons=(1−outlet C₂₋ₒᵣ₋ₘₒᵣₑ hydrocarbon concentration/inlet C₂₋ₒᵣ₋ₘₒᵣₑ hydrocarbon concentration)×100

Examples of “a catalyst for treating exhaust gas, a production method thereof, and a method for treating exhaust gas using the catalyst”

TABLE 1
Activity evaluation results

| | Active component composition | | | | | | | Reaction rates at 300° C. | | | | |
|---|---|---|---|---|---|---|---|---|---|---|---|---|
| | Active | | Active | | Active | | | (%) | | Method for preparing a | | |
| | metal (1) | | metal (2) | | metal (3) | | | C₂-or-more- | | metal colloid | | |
| | | Amount | | Amount | | Amount | Carrier | hydro- | Carbon | Reducing | | |
| No. | Species | (g/L) | Species | (g/L) | Species | (g/L) | composition | carbons | monoxide | agent | pH | Remark |
| 1 | Ir | 0.7 | — | — | — | — | γ-Al2O3 | 80 | 85 | Ethanol | 2 | 80° C., |
| | | | | | | | | | | | | 1-hour |
| | | | | | | | | | | | | reduction |
| | | | | | | | | | | | | treatment |
| 2 | Ir | 0.3 | — | — | — | — | γ-Al2O3 | 78 | 83 | Ethanol | 2 | 80° C., |
| | | | | | | | | | | | | 1-hour |
| | | | | | | | | | | | | reduction |
| | | | | | | | | | | | | treatment |
| 3 | Rh | 0.7 | — | — | — | — | γ-Al2O3 | 60 | 70 | Ethanol | 2 | 80° C., |
| | | | | | | | | | | | | 1-hour |
| | | | | | | | | | | | | reduction |
| | | | | | | | | | | | | treatment |
| 4 | Ru | 0.7 | — | — | — | — | γ-Al2O3 | 75 | 75 | Ethanol | 2 | 80° C., |
| | | | | | | | | | | | | 1-hour |
| | | | | | | | | | | | | reduction |
| | | | | | | | | | | | | treatment |
| 5 | Pt | 0.7 | — | — | — | — | γ-Al2O3 | 85 | 90 | Ethanol | 2 | 80° C., |
| | | | | | | | | | | | | 1-hour |
| | | | | | | | | | | | | reduction |
| | | | | | | | | | | | | treatment |
| 6 | Pt | 0.3 | — | — | — | — | γ-Al2O3 | 83 | 89 | Ethanol | 2 | 80° C., |
| | | | | | | | | | | | | 1-hour |
| | | | | | | | | | | | | reduction |
| | | | | | | | | | | | | treatment |
| 7 | Pd | 0.7 | — | — | — | — | γ-Al2O3 | 70 | 72 | Ethanol | 2 | 80° C., |
| | | | | | | | | | | | | 1-hour |
| | | | | | | | | | | | | reduction |
| | | | | | | | | | | | | treatment |
| 8 | PdO | 0.7 | — | — | — | — | γ-Al2O3 | 65 | 70 | Ethanol | 2 | 80° C., |
| | | | | | | | | | | | | 1-hour |
| | | | | | | | | | | | | reduction |
| | | | | | | | | | | | | treatment |
| 9 | Ag | 0.7 | — | — | — | — | γ-Al2O3 | 75 | 76 | Ethanol | 2 | 80° C., |
| | | | | | | | | | | | | 1-hour |
| | | | | | | | | | | | | reduction |
| | | | | | | | | | | | | treatment |
| 10 | Au | 0.7 | — | — | — | — | γ-Al2O3 | 50 | 55 | Ethanol | 2 | 80° C., |
| | | | | | | | | | | | | 1-hour |
| | | | | | | | | | | | | reduction |
| | | | | | | | | | | | | treatment |
| 11 | Ag2O | 0.7 | — | — | — | — | γ-Al2O3 | 75 | 80 | Ethanol | 2 | 80° C., |
| | | | | | | | | | | | | 1-hour |
| | | | | | | | | | | | | reduction |
| | | | | | | | | | | | | treatment |
| 12 | RuO2 | 0.7 | — | — | — | — | γ-Al2O3 | 58 | 60 | Ethanol | 2 | 80° C., |
| | | | | | | | | | | | | 1-hour |
| | | | | | | | | | | | | reduction |
| | | | | | | | | | | | | treatment |
| 13 | IrO2 | 0.7 | — | — | — | — | γ-Al2O3 | 67 | 70 | Ethanol | 2 | 80° C., |
| | | | | | | | | | | | | 1-hour |
| | | | | | | | | | | | | reduction |
| | | | | | | | | | | | | treatment |
| 14 | Ir | 0.3 | Pt | 0.3 | — | — | γ-Al2O3 | 88 | 92 | Ethanol | 2 | 80° C., |
| | | | | | | | | | | | | 1-hour |
| | | | | | | | | | | | | reduction |
| | | | | | | | | | | | | treatment |
| 15 | Pt | 0.3 | Pd | 0.3 | — | — | γ-Al2O3 | 88 | 92 | Ethanol | 2 | 80° C., |
| | | | | | | | | | | | | 1-hour |
| | | | | | | | | | | | | reduction |
| | | | | | | | | | | | | treatment |
| 16 | Pt | 0.3 | Pd | 0.3 | WO3 | 0.3 | γ-Al2O3 | 92 | 100 | Ethanol | 2 | 80° C., |
| | | | | | | | | | | | | 1-hour |
| | | | | | | | | | | | | reduction |
| | | | | | | | | | | | | treatment |
| 17 | Pt | 0.3 | Pd | 0.3 | MoO3 | 0.3 | γ-Al2O3 | 91 | 100 | Ethanol | 2 | 80° C., |
| | | | | | | | | | | | | 1-hour |
| | | | | | | | | | | | | reduction |
| | | | | | | | | | | | | treatment |
| 18 | Pt | 0.3 | Cr2O3 | 0.3 | — | — | γ-Al2O3 | 88 | 90 | Ethanol | 2 | 80° C., |
| | | | | | | | | | | | | 1-hour |
| | | | | | | | | | | | | reduction |
| | | | | | | | | | | | | treatment |
| 19 | Pt | 0.3 | MnO | 0.3 | — | — | γ-Al2O3 | 84 | 91 | Ethanol | 2 | 80° C., |
| | | | | | | | | | | | | 1-hour |
| | | | | | | | | | | | | reduction |
| | | | | | | | | | | | | treatment |
| 20 | Pt | 0.3 | Fe2O3 | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 21 | Pt | 0.3 | CoO | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 22 | Pt | 0.3 | CuO | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 23 | Pt | 0.3 | CeO2 | 0.3 | — | — | γ-Al2O3 | 84 | 91 | Ethanol | 2 | 80° C., |
| | | | | | | | | | | | | 1-hour |
| | | | | | | | | | | | | reduction |
| | | | | | | | | | | | | treatment |
| 24 | Pt | 0.3 | La2O3 | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 25 | Pt | 0.3 | BaO | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 26 | Pt | 0.3 | Na2O | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 27 | Pt | 0.3 | CaO | 0.3 | — | — | γ-Al2O3 | 85 | 93 | Ethanol | 2 | 80° C., |
| | | | | | | | | | | | | 1-hour |
| | | | | | | | | | | | | reduction |
| | | | | | | | | | | | | treatment |
| 28 | Pt | 0.3 | K2O | 0.3 | — | — | γ-Al2O3 | 86 | 96 | Ethanol | 2 | 80° C., |
| | | | | | | | | | | | | 1-hour |
| | | | | | | | | | | | | reduction |
| | | | | | | | | | | | | treatment |
| 29 | Pt | 0.3 | WO3 | 0.3 | — | — | γ-Al2O3 | 88 | 91 | Ethanol | 2 | 80° C., |
| | | | | | | | | | | | | 1-hour |
| | | | | | | | | | | | | reduction |
| | | | | | | | | | | | | treatment |
| 30 | Pt | 0.3 | MoO3 | 0.3 | — | — | γ-Al2O3 | 88 | 91 | Ethanol | 2 | 80° C., |
| | | | | | | | | | | | | 1-hour |
| | | | | | | | | | | | | reduction |
| | | | | | | | | | | | | treatment |
| 31 | Pt | 0.3 | V2O5 | 0.3 | — | — | γ-Al2O3 | 80 | 92 | Ethanol | 2 | 80° C., |
| | | | | | | | | | | | | 1-hour |
| | | | | | | | | | | | | reduction |
| | | | | | | | | | | | | treatment |
| 32 | Pt | 0.3 | P2O5 | 0.3 | — | — | γ-Al2O3 | 83 | 90 | Ethanol | 2 | 80° C., |
| | | | | | | | | | | | | 1-hour |
| | | | | | | | | | | | | reduction |
| | | | | | | | | | | | | treatment |
| 33 | Pt | 0.3 | Fe | 0.3 | — | — | γ-Al2O3 | 90 | 88 | Ethanol | 2 | 80° C., |
| | | | | | | | | | | | | 1-hour |
| | | | | | | | | | | | | reduction |
| | | | | | | | | | | | | treatment |
| 34 | Pt | 0.3 | Cu | 0.3 | — | — | γ-Al2O3 | 89 | 85 | Ethanol | 2 | 80° C., |
| | | | | | | | | | | | | 1-hour |
| | | | | | | | | | | | | reduction |
| | | | | | | | | | | | | treatment |
| 35 | Pt | 0.7 | — | — | — | — | α-Al2O3 | 81 | 90 | Ethanol | 2 | 80° C., |
| | | | | | | | | | | | | 1-hour |
| | | | | | | | | | | | | reduction |
| | | | | | | | | | | | | treatment |
| 36 | Pt | 0.7 | — | — | — | — | SiO2 | 80 | 90 | Ethanol | 2 | 80° C., |
| | | | | | | | | | | | | 1-hour |
| | | | | | | | | | | | | reduction |
| | | | | | | | | | | | | treatment |
| 37 | Pt | 0.7 | — | — | — | — | TiO2 | 86 | 91 | Ethanol | 2 | 80° C., |
| | | | | | | | | | | | | 1-hour |
| | | | | | | | | | | | | reduction |
| | | | | | | | | | | | | treatment |
| 38 | Pt | 0.7 | — | — | — | — | ZrO2 | 83 | 85 | Ethanol | 2 | 80° C., |
| | | | | | | | | | | | | 1-hour |
| | | | | | | | | | | | | reduction |
| | | | | | | | | | | | | treatment |
| 39 | Pt | 0.7 | — | — | — | — | SiO2—Al2O3 | 85 | 92 | Ethanol | 2 | 80° C., |
| | | | | | | | | | | | | 1-hour |
| | | | | | | | | | | | | reduction |
| | | | | | | | | | | | | treatment |
| 40 | Pt | 0.7 | — | — | — | — | TiO2—SiO2 | 85 | 87 | Ethanol | 2 | 80° C., |
| | | | | | | | | | | | | 1-hour |
| | | | | | | | | | | | | reduction |
| | | | | | | | | | | | | treatment |
| 41 | Pt | 0.7 | — | — | — | — | TiO2—Al2O3 | 85 | 87 | Ethanol | 2 | 80° C., |
| | | | | | | | | | | | | 1-hour |
| | | | | | | | | | | | | reduction |
| | | | | | | | | | | | | treatment |
| 42 | Pt | 0.7 | — | — | — | — | TiO2—ZrO2 | 85 | 87 | Ethanol | 2 | 80° C., |
| | | | | | | | | | | | | 1-hour |
| | | | | | | | | | | | | reduction |
| | | | | | | | | | | | | treatment |
| 43 | Pt | 0.7 | — | — | — | — | SO4/ZrO2 | 88 | 90 | Ethanol | 2 | 80° C., |
| | | | | | | | | | | | | 1-hour |
| | | | | | | | | | | | | reduction |
| | | | | | | | | | | | | treatment |
| 44 | Pt | 0.7 | — | — | — | — | SO4/TiO2 | 88 | 89 | Ethanol | 2 | 80° C., |
| | | | | | | | | | | | | 1-hour |
| | | | | | | | | | | | | reduction |
| | | | | | | | | | | | | treatment |
| 45 | Pt | 0.7 | — | — | — | — | SO4/TiO2—ZrO2 | 90 | 93 | Ethanol | 2 | 80° C., |
| | | | | | | | | | | | | 1-hour |
| | | | | | | | | | | | | reduction |
| | | | | | | | | | | | | treatment |
| 46 | Pt | 0.7 | — | — | — | — | γ-Al2O3 | 85 | 90 | Sodium citrate | 2 | 80° C., |
| | | | | | | | | | | | | 1-hour |
| | | | | | | | | | | | | reduction |
| | | | | | | | | | | | | treatment |
| 47 | Pt | 0.7 | — | — | — | — | γ-Al2O3 | 85 | 88 | Potassium | 2 | 80° C., |
| | | | | | | | | | | citrate | | 1-hour |
| | | | | | | | | | | | | reduction |
| | | | | | | | | | | | | treatment |
| 48 | Pt | 0.7 | — | — | — | — | γ-Al2O3 | 82 | 90 | Acetic acid | 2 | 80° C., |
| | | | | | | | | | | | | 1-hour |
| | | | | | | | | | | | | reduction |
| | | | | | | | | | | | | treatment |
| 49 | Pt | 0.7 | — | — | — | — | γ-Al2O3 | 80 | 82 | Formic acid | 2 | 80° C., |
| | | | | | | | | | | | | 1-hour |
| | | | | | | | | | | | | reduction |
| | | | | | | | | | | | | treatment |
| 50 | Pt | 0.7 | — | — | — | — | γ-Al2O3 | 79 | 81 | Malic acid | 2 | 80° C., |
| | | | | | | | | | | | | 1-hour |
| | | | | | | | | | | | | reduction |
| | | | | | | | | | | | | treatment |
| 51 | Pt | 0.7 | — | — | — | — | γ-Al2O3 | 81 | 90 | Methanol | 2 | 80° C., |
| | | | | | | | | | | | | 1-hour |
| | | | | | | | | | | | | reduction |
| | | | | | | | | | | | | treatment |
| 52 | Pt | 0.7 | — | — | — | — | γ-Al2O3 | 70 | 80 | Propanol | 2 | 80° C., |
| | | | | | | | | | | | | 1-hour |
| | | | | | | | | | | | | reduction |
| | | | | | | | | | | | | treatment |
| 53 | Pt | 0.7 | — | — | — | — | γ-Al2O3 | 81 | 81 | Diethylether | 2 | 80° C., |
| | | | | | | | | | | | | 1-hour |
| | | | | | | | | | | | | reduction |
| | | | | | | | | | | | | treatment |
| 54 | Pt | 0.7 | — | — | — | — | γ-Al2O3 | 80 | 78 | Methyl ethyl | 2 | 80° C., |
| | | | | | | | | | | ketone | | 1-hour |
| | | | | | | | | | | | | reduction |
| | | | | | | | | | | | | treatment |
| | | | — | — | — | — | | | | | | |
| Com. | Pt | 1 | — | — | — | — | γ-Al2O3 | 30 | 40 | — | — | — |
| Ex. 1 | (Impregnation | | | | | | | | | | | |
| | method) | | | | | | | | | | | |
| Com. | Pt | 0.7 | — | — | — | — | γ-Al2O3 | 50 | 60 | Sodium | — | 80° C., |
| Ex. 2 | | | | | | | | | | thiosulfate | | 1-hour |
| | | | | | | | | | | | | reduction |
| | | | | | | | | | | | | treatment |
| Com. | Pt | 0.7 | — | — | — | — | γ-Al2O3 | 70 | 75 | Ethanol | 1 | 80° C., |
| Ex. 3 | | | | | | | | | | | | 1-hour |
| | | | | | | | | | | | | reduction |
| | | | | | | | | | | | | treatment |

### INDUSTRIAL APPLICABILITY

Obtained by a method for producing a catalyst for treating exhaust gas according to the present invention, the catalyst for treating exhaust gas can be used for exhaust gases discharged from various industrial equipment such as, for example, automobiles, aircrafts, and equipment in a variety of factories.

1-2. (canceled)

3. The method for producing a catalyst for treating an exhaust gas according to claim 8, comprising mixing a reducing agent composed of an organic acid and a pH buffer solution into the aqueous metal salt solution to prepare an aqueous metal salt solution as a stock solution forming for the metal colloid solution.

4. The method for producing a catalyst for treating an exhaust gas according to claim 9, wherein the noble metal is at least one selected from the group consisting of Ir, Rh, Ru, Pt, Pd, Ag, Au, and oxides thereof.

5. The method for producing a catalyst for treating an exhaust gas according to claim 9, wherein the base metal is at least one selected from the group consisting of the metals Cr, Mn, Fe, Co, Cu, Ce, La, Ba, Na, Ca, K, W, Mo, V, P, and oxides thereof.

6. The method for producing a catalyst for treating an exhaust gas according to claim 9, wherein the carrier is at least one selected from the group consisting of SiO₂, Al₂O₃, TiO₂, ZrO₂, SiO₂—Al₂O₃, TiO₂—SiO₂, TiO₂—Al₂O₃, TiO₂—ZrO₂, SO₄/ZrO₂, SO₄/TiO₂, and SO₄/TiO₂—ZrO₂.

7. The method for producing a catalyst for treating an exhaust gas according to claim 9, comprising supporting the base metal or an oxide thereof on the catalyst for treating exhaust gas on which the colloid particles have been supported.

8. A method for producing a catalyst for treating an exhaust gas containing carbon monoxide and volatile organic compounds, characterized the method comprises:
preparing, as a pH buffer solution, a noble aqueous metal salt solution in which at least one noble metal salt is dissolved;
reductively-treating the noble aqueous metal salt solution while keeping the pH constant to prepare a noble metal colloid solution; and
immersing a carrier in the noble metal colloid solution to support the noble metal on the carrier.

9. The method for producing a catalyst for treating an exhaust gas according to claim 8, further comprising the step of:
characterized by mixing a reducing agent composed of an organic acid and a pH buffer solution into the aqueous metal salt solution to prepare an aqueous metal salt solution as a stock solution forming for the metal colloid solution.
